(19) United States
(12) Patent Application Publication
(10) Pub. No.: US 2025/0090420 A1
(43) Pub. Date: Mar. 20, 2025

(54) CLAMPING MASSAGE DEVICE

(71) Applicant: Donggen LENG, Dongguan (CN)

(72) Inventor: Donggen LENG, Dongguan (CN)

(21) Appl. No.: 18/766,704

(22) Filed: Jul. 9, 2024

(30) Foreign Application Priority Data
Sep. 18, 2023 (CN) 2023225315452

(51) Int. Cl. A61H 39/04; A61H 7/00

(52) U.S. Cl. CPC A61H 39/04; A61H 7/005; A61H 2007/009

(57) ABSTRACT

A clamping massage device includes an outer shell, a dynamic component, connecting components and massage arms. The dynamic component includes a motor and a cam connected to the motor. The connecting components include a push plate and connecting rods connected to the push plate, the push plate is disposed corresponding to the cam. The massage arms are disposed respectively corresponding to the connecting rods, and the massage arms are at least partially exposed to the outer shell. A height of the motor in the vertical direction is disposed to 12 millimeters (mm)-17 mm, and a straight distance from the output end to the fixed end is disposed in a range of 23 mm-32 mm. The device achieves purpose of pressing and clamping massage by driving the massage arms to open and close through the dynamic component, while achieving a more human-like technique and better massage effects.

### CROSS-REFERENCE TO RELATED APPLICATION

This application claims priority to Chinese patent application No. CN 202322531545.2, filed to China National Intellectual Property Administration (CNIPA) on Sep. 18, 2023, which is herein incorporated by reference in its entirety.

### TECHNICAL FIELD

The disclosure relates to the technical field of production and manufacture of massage devices, and particularly to a clamping massage device.

### BACKGROUND

Nowadays, with the development of modern society and the application of electronic devices in daily life and work, people generally have higher requirements for massage devices.

In the related art, most massage devices require a more complex mechanical structure and a larger shell to achieve the technical effect of pressing and clamping. This makes them inconvenient to use and unable to achieve a more human-like massage effect. Therefore, there is an urgent need to propose a new technical solution to address the above issues.

### SUMMARY

The purpose of the disclosure is to: in response to the shortcomings of the related art, a clamping massage device that can achieve better massage effects and has a smaller size in appearance design is provided, which is convenient to carry.

To achieve above purpose, the technical solutions are as follows.

A clamping massage device includes an outer shell, a dynamic component, connecting components and massage arms. The dynamic component includes a motor and a cam connected to the motor. The connecting components include a push plate and connecting rods connected to the push plate, the push plate is disposed corresponding to the cam, and a number of the connecting rods is as least two. The massage arms are disposed respectively corresponding to the connecting rods, the massage arms are disposed opposite each other, and the massage arms are at least partially exposed to the outer shell. The dynamic component, the connecting components and the massage arms are sequentially connected, and the dynamic component and the connecting components are disposed in the outer shell. The motor includes an output end and a fixed end disposed opposite each other, the output end is connected to the cam, and the fixed end is connected to the outer shell. A first straight line between each of connecting component and a corresponding one of the massage arms is in a vertical direction, and a second straight line between the output end and the fixed end is perpendicular to the vertical direction. A height of the motor in the vertical direction is disposed in a range of 12 millimeters (mm)-17 mm, and a straight distance from the output end to the fixed end is disposed in a range of 23 mm-32 mm.

In an embodiment, the height of the motor in the vertical direction is disposed to 12 mm, and the straight distance from the output end to the fixed end is disposed to 23 mm.

In an embodiment, each of the massage arms includes a first massage arm defined with a first connecting through-hole and a second massage arm defined with a second connecting through-hole, the first massage arm is disposed outside the outer shell.

In an embodiment, the outer shell includes a first shell body and a second shell body, the first shell body is fixedly connected to the second shell body through installation pieces.

In an embodiment, the installation pieces can be screws, sealing pins, dowel pins, and various other devices used for fixed connections, making the first shell body and the second shell body closely connected and increasing the connection stability of the massage device.

In an embodiment, the first connecting through-hole is provided with a first rotating shaft, and both the first shell body and the second shell body are provided with fixing parts matching the first rotating shaft, respectively. Two ends of the first rotating shaft are respectively connected to the fixing parts. The first rotating shaft ensures that the massage arms can operate normally for pressing and clamping actions while also fixing the position of the massage arms, which prevents them from shifting during operation, thereby preventing injury to the user.

In an embodiment, the first massage arm and the second massage arm are disposed inclinedly to form an angle in a range of 90°-180° between the first massage arm and the second massage arm.

In an embodiment, each of the connecting rods includes a connecting body and a second rotating shaft, the second rotating shaft is disposed on a side of the connecting body closed to the each of the massage arms, and the second rotating shaft is disposed in the second connecting through-hole. The second rotating shaft is configured to connect the connecting rods with the massage arms in a movable manner, achieving the desired transmission effect.

In an embodiment, the push plate is provided with protrusions symmetrically disposed thereon, and the connecting body is provided with a third connecting through-hole corresponding to a corresponding one of the protrusions.

In an embodiment, the cam includes a cam main body and a cam moving body connected to each other, the cam moving body extends from the cam main body; a side of the push plate closed to the cam is defined with a groove corresponding to the cam moving body, and the cam moving body is movably disposed in the groove. The cam moving body is capable of driving the push plate to move, ensuring the continuity of the massage actions.

In an embodiment, a length of the groove in a horizontal direction is the same as a width of the push plate in the horizontal direction.

In an embodiment, the motor is disposed in an isolation component, the isolation component includes an upper piece and a lower piece fixedly connected to the outer shell. The upper piece and the lower piece both include arc-shaped parts, respectively, and a shape of each of the arc-shaped parts matches a shape of the motor.

The beneficial effects of the disclosure are as follows.
(1) The clamping massage device includes an outer shell, a dynamic component, connecting components and massage arms. The dynamic component includes a motor and a cam connected to the motor. The connecting components include a push plate and connecting rods connected to the push plate, the push plate is disposed corresponding to the cam, and a number of the connecting rods is as least two. The massage arms are disposed respectively corresponding to the connecting rods, the massage arms are disposed opposite each other, and the massage arms are at least partially exposed to the outer shell. The dynamic component, the connecting components and the massage arms are sequentially connected, and the dynamic component and the connecting components are disposed in the outer shell. The motor includes an output end and a fixed end disposed opposite each other, the output end is connected to the cam, and the fixed end is connected to the outer shell, a first straight line between each of connecting component and a corresponding one of massage arm is in a vertical direction, and a second straight line between the output end and the fixed end is perpendicular to the vertical direction. A height of the motor in the vertical direction is disposed in a range of 12 mm-17 mm, and a straight distance from the output end to the fixed end is disposed in a range of 23 mm-32 mm. The clamping massage device of the disclosure uses a motor to provide power for the pressing action of the massage arms. Its working process is as follows: the motor drives the rotation of the cam, the cam drives the push plate to move up and down, the movement of the push plate drives the motion of the connecting rods, which in turn causes the massage arms to swing. Since the massage arms are disposed opposite each other, the ends of the massage arms that come into contact with the human body can perform clamping actions, achieving a better human-like massage effect.
(2) Due to the small size of the motor used in the clamping massage device of the disclosure and its relative transverse placement to the connecting components and the massage arms, the outer shell in the clamping massage device can be disposed to a smaller size, and the shape of the outer shell is not limited by internal components, which can be disposed according to actual needs and usage needs.

### BRIEF DESCRIPTION OF DRAWINGS

The following will refer to the attached drawings to describe the features, advantages, and technical effects of embodiments of the disclosure.

FIG. 1 illustrates a structural schematic diagram of a clamping massage device of the disclosure.

FIG. 2 illustrates a structural schematic diagram of the clamping massage device without a second shell body of the disclosure.

FIG. 3 illustrates a structural schematic diagram of the clamping massage device without an outer shell of the disclosure.

Description of reference numerals: 1. outer shell; 11. first shell body; 12. second shell body; 13. fixing part; 14. installation piece; 2. dynamic component; 21. motor; 22. cam; 221. cam main body; 222. cam moving body; 3. connecting component; 31. push plate; 311. protrusion; 312. groove; 32. connecting rod; 321. connecting body; 322. second rotating shaft; 323. third connecting through-hole; 4. massage arm; 41. first massage arm; 42. first connecting through-hole; 43. second massage arm; 44. second connecting through-hole; 45. first rotating shaft; 5. isolation component; 51. upper piece; 52. lower piece; 53. arc-shaped part; A. vertical direction.

### DETAILED DESCRIPTION OF EMBODIMENTS

When certain terms are used in the specification and claims to refer to specific components. Those skilled in the art should understand that hardware manufacturers may use different terms to refer to the same component. This specification and claims do not differentiate components based on differences in name, but rather on differences in functionality of the components. As the term “include” mentioned throughout the entire specification and claims is an open-ended term, it should be interpreted as “include but not limited to”. The term “approximate” refers to the ability of those skilled in the art to solve technical problems within an acceptable range of error and achieve basic technical results. In addition, the terms “first”, “second”, etc. are only used to describe the purpose and cannot be understood as indicating or implying relative importance.

In the disclosure, it should be understood that the terms “up”, “down”, “front”, “back”, “left”, “right” and “horizontal” indicate the orientation or position relationship based on the orientation or position relationship shown in the attached drawings, only for the convenience of describing the disclosure and simplifying the description, rather than indicating or implying that the device or component referred to must have a specific orientation, be constructed and operated in a specific orientation, and therefore cannot be understood as a limitation on the disclosure.

In the disclosure, unless otherwise specified and limited, the terms “install”, “connect”, “contact”, “fix” and other terms should be broadly understood, for example, they can be fixed connections, detachable connections, or integrated connections; It can be a mechanical connection or an electrical connection. It can be directly connected, or indirectly connected through an intermediate medium, or it can be an internal connection between two components. For those skilled in the art, the specific meanings of the above terms in the disclosure can be understood based on specific circumstances.

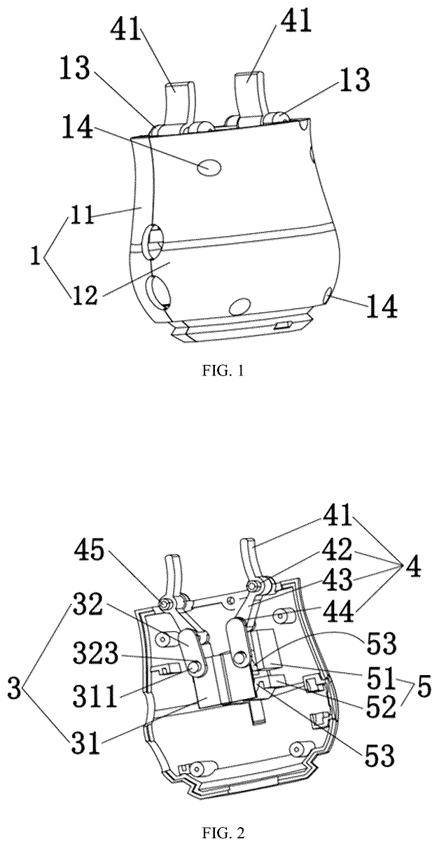

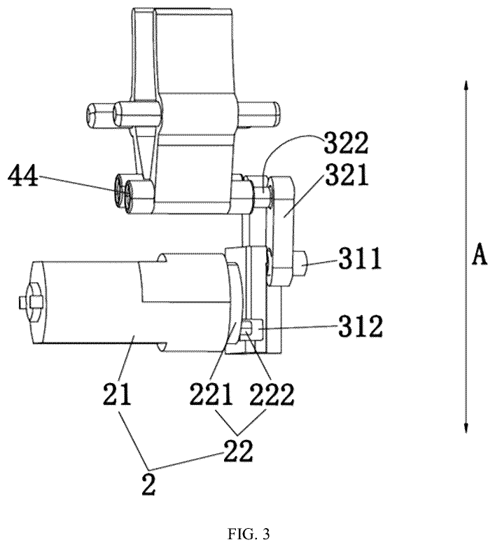

The following provides further detailed explanations of the disclosure in conjunction with FIGS. 1-3 and specific embodiment, but does not serve as a limitation on the disclosure.

As shown in FIGS. 1-3, a clamping massage device includes an outer shell 1, a dynamic component 2, connecting components 3 and massage arms 4, and the dynamic component 2, the connecting components 3 and the massage arms 4 are sequentially connected. The dynamic component 2 and the connecting components 3 are disposed in the outer shell 1, and the massage arms 4 are at least partially exposed to the outer shell 1. The dynamic connections between the components ensures the continuity of the massage actions, and the setting of the outer shell 1 can prevent dust and debris from entering an interior of the massage device, thereby extending its service life.

In an embodiment, the motor 21 includes an output end and a fixed end disposed opposite each other, the output end is connected to the cam 22, and the fixed end is connected to the outer shell 1. A first straight line between each of connecting components 3 and a corresponding one of the massage arms 4 is in a vertical direction A, and a second straight line between the output end and the fixed end is perpendicular to the vertical direction A. A height of the motor 21 in the vertical direction A is disposed in a range of 12 millimeters (mm)-17 mm, and a straight distance from the output end to the fixed end is disposed in a range of 23 mm-32 mm. In the embodiment, the motor 21 is used as a N20 planetary gear box, the height of the motor 21 in the vertical direction A is disposed to 12 mm, and the straight distance from the output end to the fixed end is disposed to 23 mm. The size of the motor is relatively small, and other models of motors can also be used, as long as they meet the size requirements.

In an embodiment, the outer shell 1 includes a first shell body 11 and a second shell body 12, the first shell body 11 is fixedly connected to the second shell body 12 through installation pieces 14. In the embodiment, the installation pieces 14 are screws, but they can also be set as pins, sealing pins, or other devices used for fixed connections to enhance the connection stability of the outer shell 1.

In the embodiment, the shape of outer shell 1 is disposed as a round-bellied vase shape, and the outer shell 1 includes a central round belly that protrudes relative to both ends, which can match the curvature of the human palm, improving the comfort of the massage device when in use. It can also evenly distribute the impact force when the massage device is accidentally dropped, playing a shock-absorbing role. In some other embodiments, the outer shell 1 can be disposed as a gourd shape or a streamlined shape and other shapes that are easy to grasp, or the outer shell 1 can also be disposed as a star shape or a rose shape to increase aesthetics, as long as there are corresponding openings, fixing components, and internal space, there are no specific limitations being made to the shape of the outer shell 1.

In an embodiment, the massage arms 4 are respectively provided corresponding to the connecting components 3, and the massage arms 4 are disposed opposite each other, which enables the ends of the massage arms 4 exposed outside the outer shell 1 to smoothly complete the clamping action. Each of the massage arms 4 includes a first massage arm 41 defined with a first connecting through-hole 42 and a second massage arm 43 defined with a second connecting through-hole 44, the first massage arm 41 is at least partially exposed to the outer shell 1. The first massage arm 41 and the second massage arm 43 are disposed inclinedly to form an angle in a range of 90°-180° between the first massage arm 41 and the second massage arm 43, the angle is specifically selected as in a range of 110°-160°, which can ensure the normal implementation of the clamping action. The first connecting through-hole 42 is provided with a first rotating shaft 45, and both the first shell body 11 and the second shell body 12 are provided with fixing parts 13 matching the first rotating shaft 45, respectively. Two ends of the first rotating shaft 45 are respectively connected to the fixing parts 13. The first rotating shaft 45 can ensure that the massage arms 4 are fixed in position relative to the outer shell 1, which prevents the massage arms 4 from shifting during operation and causing injury to the user.

In an embodiment, the first massage arm 41 may be provided with structures such as silicone protrusions, convex beads, or sponge meshes, which can further enhance the massage effect.

In an embodiment, the connecting components 3 include a push plate 31 and connecting rods 32 connected to the push plate 31, and the push plate 31 is disposed corresponding to the cam 22. The number of the connecting rods 32 is as least two, and the massage arms 4 are disposed respectively corresponding to the connecting rods 32. Each of the connecting rods 32 includes a connecting body 321 and a second rotating shaft 322, the second rotating shaft 322 is disposed on a side of the connecting body 321 closed to the each of the massage arms 4, and the second rotating shaft 322 is disposed in the second connecting through-hole 44. The push plate 31 is provided with protrusions 311 symmetrically disposed thereon, and the connecting body 321 is provided with a third connecting through-hole 323 corresponding to a corresponding one of the protrusions 311. The above setting further strengthens the transmission relationship between the components, ensuring the continuity and feasibility of clamping actions.

In an embodiment, the dynamic component 2 includes a motor 21 and a cam 22 connected to the motor 21. In the embodiment, the motor 21 can be provided with a gearbox or other settings, as long as it can provide power, without specific regulations. The cam 22 includes a cam main body 221 and a cam moving body 222 connected to each other, the cam moving body 222 extends from the cam main body 221. A side of the push plate 31 closed to the cam 22 is defined with a groove 312 corresponding to the cam moving body 222, the cam moving body 222 is movably disposed in the groove 312, and a length of the groove 312 in a horizontal direction is the same as a width of the push plate 31 in the horizontal direction. During the operation, the cam moving body 222 follows the cam main body 221 to perform repeated circular motion, which in turn drives the up and down movement of the push plate 31. The setting of the length of the groove 312 allows the cam moving body 222 to drive the push plate 31 to its maximum extent, and also ensures the force balance of the push plate 31, thereby ensuring the stable operation of the entire massage device.

In an embodiment, the protrusions 311, the connecting components 3, and the massage arms 4 are all correspondingly provided, the number is same, and all are set with even number, as well as multiple corresponding protrusions 311, connecting components 3, and massage arms 4 that are symmetrically arranged. This can maximize the guarantee that both sides of the massage arms 4 have the same force when in contact with the human body, further ensuring the massage effect.

In an embodiment, the clamping massage device further includes an isolation component 5, the isolation component includes an upper piece 51 and a lower piece 52, which are fixed or integrated with the outer shell 1. The upper piece 51 and the lower piece 52 both include arc-shaped parts 53, respectively, and a shape of each of the arc-shaped parts 53 matches a shape of the motor 21, which means that the arc-shaped parts 53 are respectively attached to the upper end and the lower end of motor 21, and the isolation component 5 is configured to fix the position of motor 21, ensuring the stability of the massage device.

In an embodiment, the isolating component 5 utilizes a shock-absorbing material to further increase the user's comfort, or the isolating component 5 can utilize a silent material to reduce the noise of the massage device during the operation, maintaining a quiet environment.

According to the disclosure and instruction in the specification, those skilled in the art can also make changes and modifications to the embodiments. Therefore, the disclosure is not limited to the specific embodiment mentioned above. Any obvious improvements, replacements, or variations made by those skilled in the art on the basis of the disclosure belong to the scope of protection of the disclosure. In addition, although specific terms are used in the specification, these terms are only for convenience and do not constitute any limitation on the disclosure.

What is claimed is:

1. A clamping massage device, comprising:
an outer shell (1);
a dynamic component (2), wherein the dynamic component (2) comprises a motor (21) and a cam (22) connected to the motor (21);
connecting components (3), wherein the connecting components (3) comprise a push plate (31) and connecting rods (32) connected to the push plate (31), the push plate (31) is disposed corresponding to the cam (22), and a number of the connecting rods (32) is as least two;
massage arms (4), wherein the massage arms (4) are disposed respectively corresponding to the connecting rods (32), the massage arms (4) are disposed opposite each other, and the massage arms (4) are at least partially exposed to the outer shell (1);
wherein the dynamic component (2), the connecting components (3) and the massage arms (4) are sequentially connected, and the dynamic component (2) and the connecting components (3) are disposed in the outer shell (1); the motor (21) comprises an output end and a fixed end disposed opposite each other, the output end is connected to the cam (22), and the fixed end is connected to the outer shell (1); a first straight line between each of connecting components (3) and a corresponding one of the massage arms (4) is in a vertical direction (A), and a second straight line between the output end and the fixed end is perpendicular to the vertical direction (A); a height of the motor (21) in the vertical direction (A) is disposed in a range of 12 millimeters (mm)-17 mm, and a straight distance from the output end to the fixed end is disposed in a range of 23 mm-32 mm.

2. The clamping massage device as claimed in claim 1, wherein the height of the motor (21) in the vertical direction (A) is disposed to 12 mm, and the straight distance from the output end to the fixed end is disposed to 23 mm.

3. The clamping massage device as claimed in claim 1, wherein each of the massage arms (4) comprises a first massage arm (41) defined with a first connecting through-hole (42) and a second massage arm (43) defined with a second connecting through-hole (44), the first massage arm (41) is disposed outside the outer shell (1); the outer shell (1) comprises a first shell body (11) and a second shell body (12), the first shell body (11) is fixedly connected to the second shell body (12) through installation pieces (14).

4. The clamping massage device as claimed in claim 3, wherein the first connecting through-hole (42) is provided with a first rotating shaft (45), and both the first shell body (11) and the second shell body (12) are provided with fixing parts (13) matching the first rotating shaft (45), respectively; two ends of the first rotating shaft (45) are respectively connected to the fixing parts (13).

5. The clamping massage device as claimed in claim 3, wherein the first massage arm (41) and the second massage arm (43) are disposed inclinedly to form an angle in a range of 90°-180° between the first massage arm (41) and the second massage arm (43).

6. The clamping massage device as claimed in claim 3, wherein each of the connecting rods (32) comprises a connecting body (321) and a second rotating shaft (322), the second rotating shaft (322) is disposed on a side of the connecting body (321) closed to the each of the massage arms (4), and the second rotating shaft (322) is disposed in the second connecting through-hole (44).

7. The clamping massage device as claimed in claim 6, wherein the push plate (31) is provided with protrusions (311) symmetrically disposed thereon, and the connecting body (321) is provided with a third connecting through-hole (323) corresponding to a corresponding one of the protrusions (311).

8. The clamping massage device as claimed in claim 1, wherein the cam (22) comprises a cam main body (221) and a cam moving body (222) connected to each other, the cam moving body (222) extends from the cam main body (221); a side of the push plate (31) closed to the cam (22) is defined with a groove (312) corresponding to the cam moving body (222), and the cam moving body (222) is movably disposed in the groove (312).

9. The clamping massage device as claimed in claim 8, wherein a length of the groove (312) in a horizontal direction is the same as a width of the push plate (31) in the horizontal direction.

10. The clamping massage device as claimed in claim 1, wherein the motor (21) is disposed in an isolation component (5), the isolation component comprises an upper piece (51) and a lower piece (52) fixedly connected to the outer shell (1); the upper piece (51) and the lower piece (52) both comprise arc-shaped parts (53), respectively, and a shape of each of the arc-shaped parts (53) matches a shape of the motor (21).

11. A clamping massage device, comprising:
an outer shell (1);
a dynamic component (2), comprising a motor (21) and a cam (22) connected to the motor (21), wherein the motor (21) comprises an output end and a fixed end disposed opposite each other, the output end is connected to the cam (22), and the fixed end is connected to the outer shell (1);
connecting components (3), comprising a push plate (31) and connecting rods (32) connected to the push plate (31), the push plate (31) is disposed corresponding to the cam (22);
massage arms (4), disposed opposite each other and respectively corresponding to the connecting rods (32); and
an isolation component (5), matched with the motor (21);
wherein the outer shell (1), the connecting components (3), and the massage arms (4) are symmetrically arranged along a vertical direction (A); the fixed end and the output end of the motor (21) and the cam (22) are arranged along a horizontal direction perpendicular to the vertical direction (A);
wherein each of the massage arms (4) comprises a first massage arm (41) and a second massage arm (43), the first massage arm (41) is at least partially exposed to the outer shell (1), the first massage arm (41) and the second massage arm (43) are disposed inclinedly to form an angle in a range of 90°-180° between the first massage arm (41) and the second massage arm (43); and
wherein a height of the motor (21) in the vertical direction (A) is disposed in a range of 12-17 mm, and a distance from the output end to the fixed end in the horizontal direction is disposed in a range of 23-32 mm.

12. The clamping massage device as claimed in claim 11, wherein the outer shell comprises a first shell body (11) and a second shell body (12), and the first shell body (11) is fixedly connected to the second shell body (12) through installation pieces (14); and
the first massage arm (41) is defined with a first connecting through-hole (42), the first connecting through-hole (42) is provided with a first rotating shaft (45), and both the first shell body (11) and the second shell body (12) are provided with fixing parts (13) matching the first rotating shaft (45), respectively; two ends of the first rotating shaft (45) are respectively connected to the fixing parts (13).

13. The clamping massage device as claimed in claim 11, wherein the cam (22) comprises a cam main body (221) and a cam moving body (222) connected to each other, the cam moving body (222) extends from the cam main body (221);
a side of the push plate (31) closed to the cam (22) is defined with a groove (312) corresponding to the cam moving body (222), and the cam moving body (222) is movably disposed in the groove (312); and
a length of the groove (312) in the horizontal direction is the same as a width of the push plate (31) in the horizontal direction.
